(19) United States
(12) Patent Application Publication
(10) Pub. No.: US 2017/0357522 A1
(43) Pub. Date: Dec. 14, 2017

(54) SYSTEM, METHOD, AND COMPUTER PROGRAM FOR CONTROLLING CONFIGURATION IMPLEMENTATION

(71) Applicant: Lenovo Enterprise Solutions (Singapore) Pte. Ltd., Singapore (SG)

(72) Inventors: Fred Allison Bower, III, Durham, NC (US); Scott Kelso, Cary, NC (US)

(21) Appl. No.: 15/179,923

(22) Filed: Jun. 10, 2016

(51) Int. Cl. G06F 9/445; H04L 9/32

(52) U.S. Cl. CPC G06F 9/44505; H04L 9/3263; H04L 9/3247; H04L 9/3236

(57) ABSTRACT

A computer program embodied on a tangible computer readable medium includes computer code for identifying a stored configuration of a system, computer code for determining whether the stored configuration of the system includes digital signatures of each of a plurality of parties, and computer code for conditionally implementing a current configuration of the system, based on the determining.

### FIELD OF THE INVENTION

The present invention relates to leased computing, and more particularly to controlling the configuration of a leased system.

### BACKGROUND

In bare metal leased computing scenarios such as bare-metal-as-a-service and co-location, both the landlord and the tenant desire some degree of control over the BMC and UEFI. The boundary differs from situation to situation, so it is not satisfactory to simply create distinct roles and give each role control over a pre-defined portion of the configuration. It is therefore desirable to support multi-party control over configuration implementation.

### SUMMARY

A computer program embodied on a tangible computer readable medium includes computer code for identifying a stored configuration of a system, computer code for determining whether the stored configuration of the system includes digital signatures of each of a plurality of parties, and computer code for conditionally implementing a current configuration of the system, based on the determining.

A method includes identifying a stored configuration of a system, determining whether the stored configuration of the system includes digital signatures of each of a plurality of parties, and conditionally implementing a current configuration of the system, based on the determining.

A system according to another embodiment includes a processor and logic integrated with and/or executable by the processor, the logic being configured to identify a system configuration, calculate a hash value for the system configuration, create a signed hash value utilizing the hash value and a plurality of private keys, and store the signed hash value.

### BRIEF DESCRIPTION OF THE DRAWINGS

FIG. 1 illustrates a network architecture, in accordance with one possible embodiment.

FIG. 2 illustrates an exemplary system, in accordance with one embodiment.

FIG. 3 illustrates a method for controlling configuration implementation, in accordance with one embodiment.

FIG. 4 illustrates a method for creating a hashed, signed system configuration, in accordance with one embodiment.

FIG. 5 illustrates a method for verifying signatures and configurations, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

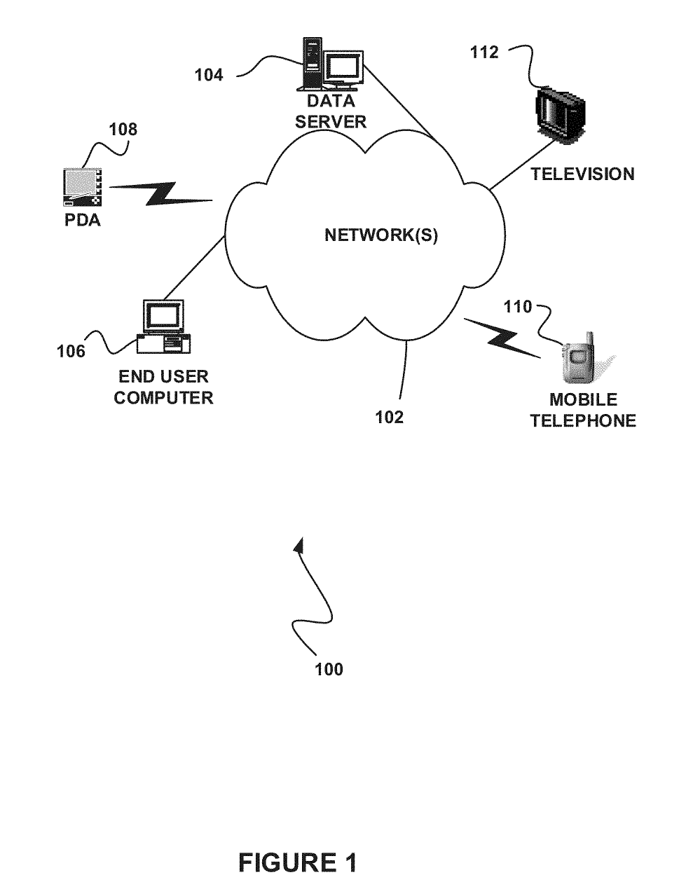

FIG. 1 illustrates a network architecture 100, in accordance with one possible embodiment. As shown, at least one network 102 is provided. In the context of the present network architecture 100, the network 102 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 102 may be provided.

Coupled to the network 102 is a plurality of devices. For example, a server computer 104 and an end user computer 106 may be coupled to the network 102 for communication purposes. Such end user computer 106 may include a desktop computer, lap-top computer, and/or any other type of logic. Still yet, various other devices may be coupled to the network 102 including a personal digital assistant (PDA) device 108, a mobile phone device 110, a television 112, etc.

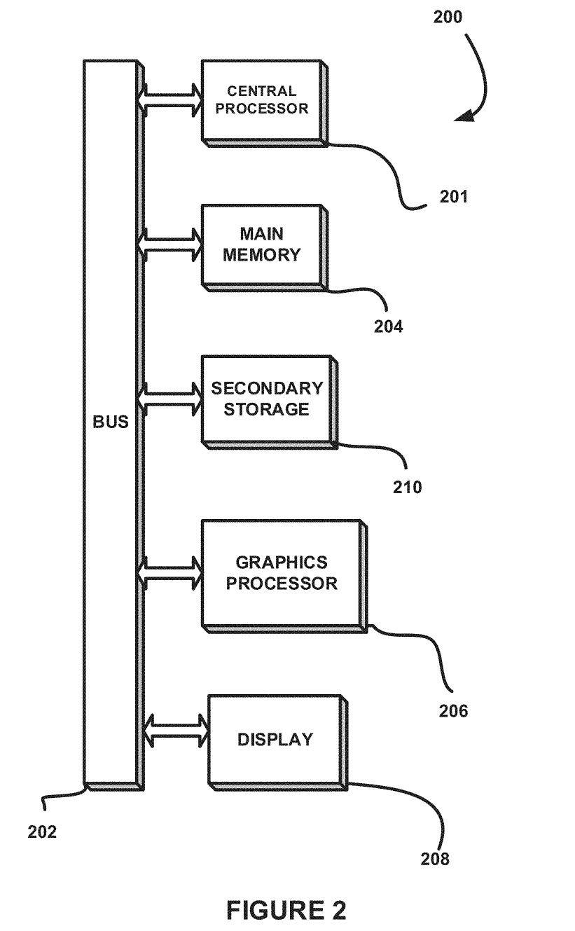

FIG. 2 illustrates an exemplary system 200, in accordance with one embodiment. As an option, the system 200 may be implemented in the context of any of the devices of the network architecture 100 of FIG. 1. Of course, the system 200 may be implemented in any desired environment.

As shown, a system 200 is provided including at least one central processor 201 which is connected to a communication bus 202. The system 200 also includes main memory 204 [e.g. random access memory (RAM), etc.]. The system 200 also includes a graphics processor 206 and a display 208.

The system 200 may also include a secondary storage 210. The secondary storage 210 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 204, the secondary storage 210, and/or any other memory, for that matter. Such computer programs, when executed, enable the system 200 to perform various functions (to be set forth below, for example). Memory 204, storage 210, volatile or non-volatile storage, and/or any other type of storage are possible examples of non-transitory computer-readable media.

The invention can also be provided in the form of a computer program product comprising a computer readable storage or signal medium having computer code thereon, which may be executed by a computing device (e.g., a processor) and/or system. A computer readable storage medium can include any medium capable of storing computer code thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

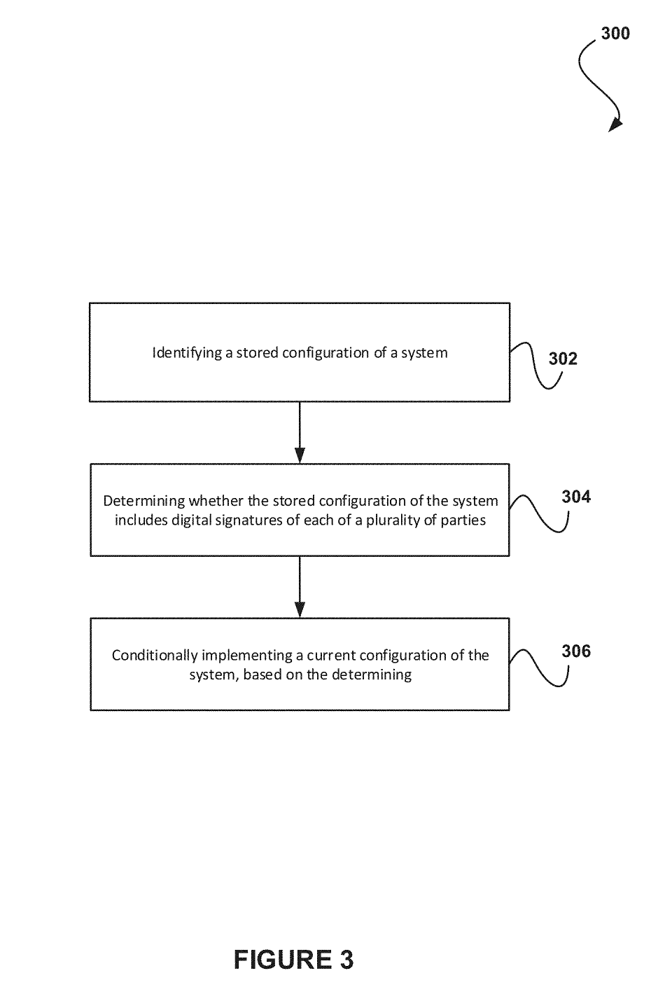

FIG. 3 illustrates a method 300 for controlling configuration implementation, in accordance with one embodiment. As an option, the method 300 may be carried out in the context of the details of FIGS. 1-2 and 4-5. Of course, however, the method 300 may be carried out in any desired environment. Further, the aforementioned definitions may equally apply to the description below.

As shown in operation 302, a stored configuration of a system is identified. In one embodiment, this identification may be performed by the system. In another embodiment, the stored system configuration may include a plurality of settings associated with software and/or hardware. For example, the stored system configuration may include a firmware image. In another embodiment, the stored system configuration may include a subsystem firmware image. In yet another embodiment, the stored system configuration may include an identification of one or more memory locations. For example, the stored system configuration may include an identification of a nonvolatile memory storing the system configuration. In still another embodiment, the stored configuration may be hashed. In still another embodiment, the stored configuration may be hashed, signed, etc.

Additionally, in one embodiment, the system may include a server. For example, the system may include an entirety of a hardware server, one or more portions of the hardware server, etc. In another embodiment, the system may include a bare metal server (e.g., the physical server itself), software running within the server, hardware installed within the server, firmware installed within the server, etc. In yet another embodiment, the system may be rented to one or more parties. For example, the system may be rented by one or more owners/lessors to one or more tenants/lessees.

In yet another embodiment, the server may include a physical server including a plurality of sub-modules. For example, the physical server may include sub-modules such as a baseboard management controller (BMC), a compute structure (e.g., a central processing unit (CPU) and unified extensible firmware interface (UEFI) firmware, etc.), a network interface, a storage interface, etc. In still another embodiment, each sub-module may include firmware that includes a configuration. For example, the stored configuration of the system may include a configuration of one or more sub-modules of the server.

Also, in one embodiment, the stored configuration of the system may be identified in response to a start-up of the system. In another embodiment, the stored configuration of the system may be identified in response to a request to validate a current configuration of the system. Of course, however, the stored configuration of the system may be identified in response to any initiating criteria.

Further, as shown in operation 304, it is determined whether the stored configuration of the system includes digital signatures of each of a plurality of parties. In one embodiment, this determination may be performed by the system. In another embodiment, the plurality of parties may include at least one lessor of the system and at least one lessee of the system. For example, it may be determined whether both a lessor of the system and a lessee of the system have digitally signed the stored configuration.

Further still, in one embodiment, the digital signatures of the plurality of parties may be included within the stored configuration as a result of a creation of a mutually secured configuration. For example, creating the mutually secured configuration may include creating and storing a certificate for each of the plurality of parties. For instance, the certificate created for each party may include a cryptographic certificate. In another embodiment, the certificate created for each party may include a public key for that party that is signed and encrypted. For example, each certificate may include a public key for a party that is signed and encrypted using a private key of a certificate authority.

Also, in one embodiment, the certificate stored for each party may be used for digitally signing content by that party. In another embodiment, each of the plurality of certificates may be stored in a trusted and secure location (e.g., a trusted platform module, etc.).

In addition, in one embodiment, creating the mutually secured configuration may include calculating a hash value for the identified system configuration. For example, a cryptographic hash function may be applied to the stored configuration to produce a hash value (e.g., a digest, etc.). In another embodiment, the creation of the mutually secured configuration may include adding the digital signatures of the plurality of parties to the hash value for the identified system configuration.

For example, creating the mutually secured configuration may include applying a signature of each of the plurality of parties to the hash value. For instance, each of the plurality of parties may sign the hash value with a private key associated with their stored certificate, and such signatures may be applied to the hash value (e.g., by encrypting the hash value with each of the private keys of the plurality of parties to create a digital signature, etc.). In another example, each of the plurality of parties may have their signatures applied to the hash value in parallel. In another embodiment, for each of the plurality of parties, the signature may be received from the party and applied to the hash value when the party confirms that they are satisfied with the identified system configuration (e.g., the system configuration that was hashed, etc.). In yet another embodiment, the signed hash value may be stored in a trusted and secure location within the system.

Furthermore, in one embodiment, determining whether the stored configuration of the system includes digital signatures of each of the plurality of parties may include retrieving stored certificates for each of the plurality of parties and verifying each of the digital signatures of each of the plurality of parties, utilizing the retrieved certificates. For example, a signature check may be performed using the retrieved certificates by decrypting the digital signature with public keys obtained via the retrieved certificates.

Further still, as shown in operation 306, a current configuration of the system is conditionally implemented, based on the determining. In one embodiment, this conditional implementation may be performed by the system. In another embodiment, the current configuration of the system may include the configuration that is currently being implemented by the system. In another embodiment, the current configuration of the system may include a configuration that is to be implemented by the system at a start-up of the system. In yet another embodiment, implementing the current configuration of the system may include utilizing the current configuration (e.g., one or more settings, a firmware image, etc.) when running the system.

Also, in one embodiment, when it is determined that the stored configuration of the system includes digital signatures of each of the plurality of parties, the stored configuration may then be compared to the current configuration of the system. For example, the current configuration may be hashed and compared to the hash of the stored configuration obtained as a result of decrypting the signed hash value. In another example, when the hashed current configuration matches the hashed stored configuration, the current configuration may be implemented by the system. In yet another example, when the hashed current configuration does not match the hashed stored configuration, the current configuration may not be implemented by the system.

Additionally, in one embodiment, when it is determined that the stored configuration of the system does not include digital signatures of each of the plurality of parties, the current configuration of the system may not be implemented. For example, the system may not boot, the system may boot utilizing another configuration (e.g., a default configuration, etc.), etc. In another example, one or more parties, (e.g., one or more lessors, one or more lessees, etc.) may be notified that the current configuration is not implemented.

In this way, mutual consent by all of the plurality of parties to the stored configuration may be required in order for a current configuration matching the stored configuration to be implemented by the system. This may protect all parties against firmware and settings changes, unless all parties agree on such changes.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

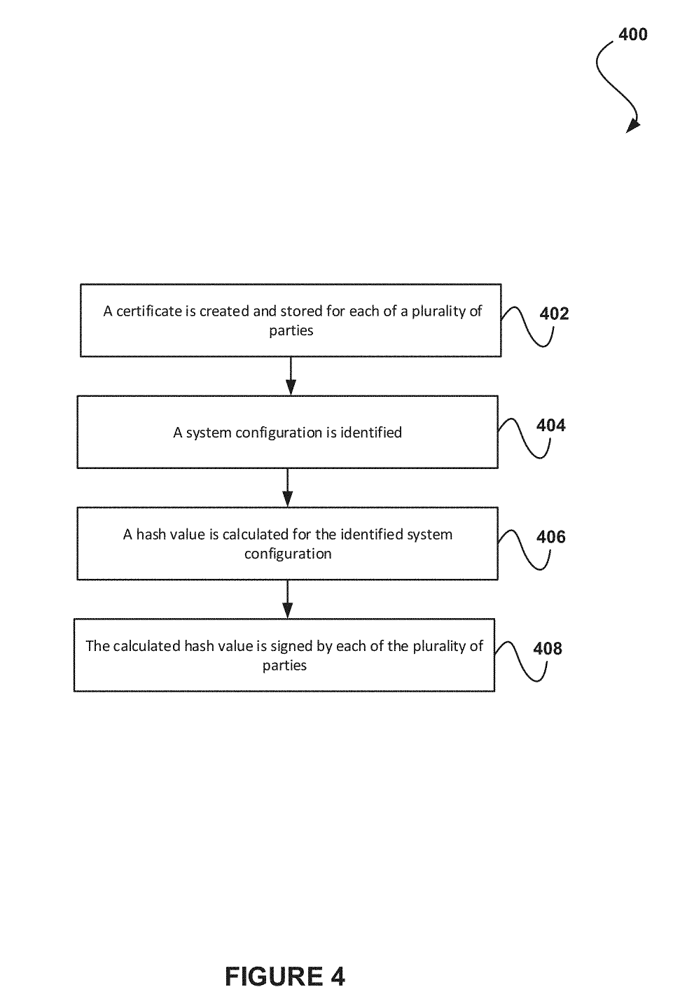

FIG. 4 illustrates method 400 for creating a hashed, signed system configuration, in accordance with one embodiment. As an option, the method 400 may be carried out in the context of the details of FIGS. 1-3 and 5. Of course, however, the method 400 may be carried out in any desired environment. Further, the aforementioned definitions may equally apply to the description below.

As shown in operation 402, a certificate is created and stored for each of a plurality of parties. In one embodiment, the plurality of parties may include an owner of a system (e.g., an owner of a hardware server, a lessor of the hardware server, etc.). In another embodiment, the plurality of parties may include a renter of the system (e.g., a lessee of the system, etc.). In yet another embodiment, the certificate may include a cryptographic certificate. For example, the certificate may include a public key of the party that is signed and encrypted (e.g., signed and encrypted using a private key of a certificate authority, etc.).

In another example, each participant may create a cryptographic certificate suitable for digitally signing content. All certificates may be saved in a trusted and secure location, such as a trusted platform module (TPM). In this way, each party may give their public key to others, where others can trust that the public key came from the party.

Additionally, in one embodiment, each certificate may be used by its respective party for confirming the digital signing of content by that party. In another embodiment, the certificate may be saved in a trusted and secure location (e.g., a trusted platform module (TPM), etc.).

Further, as shown in operation 404, a system configuration is identified. In one embodiment, the system configuration may include a firmware image (e.g., a subsystem firmware image, etc.). In another embodiment, the system configuration may include an identification of a nonvolatile memory storing the configuration. In yet another embodiment, the system associated with the configuration may include a server (e.g., a server rented to one or more of the plurality of parties by another of the plurality of parties).

Further still, as shown in operation 406, a hash value is calculated for the identified system configuration. In one embodiment, the hash value may include a digest. In another embodiment, the hash value may be calculated utilizing a cryptographic hash function. For example, the cryptographic hash function may be applied to the configuration to produce a digest. In another example, a hash may be calculated for each subsystem firmware image, and each nonvolatile memory block storing the subsystem configuration.

Also, as shown in operation 408, the calculated hash value is signed by each of the plurality of parties. In one embodiment, each party may sign hash value with a private key associated with that party's cryptographic certificate (e.g., the verified public key). For example, the hash value may be signed by encrypting the digest (hash value) with the private key of the party to produce a digital signature. In another embodiment, the calculated hash value may be signed by all parties in parallel (e.g., by encrypting the hash value with the private keys of each of the plurality of parties, etc.).

In another embodiment, each party may sign the calculated hash value when they confirm they are satisfied with the identified system configuration for which the hash value is calculated. In yet another embodiment, the signed hash value (e.g., the digital signature, etc.) may be stored in a trusted and secure location (e.g., of the system, of an external system, etc.). For example, each party may confirm they are satisfied with the captured configuration, and may digitally sign the content/hash with their certificate. The signature may also be stored in a trusted and secure location.

In this way, a hashed, signed system configuration may be created and stored.

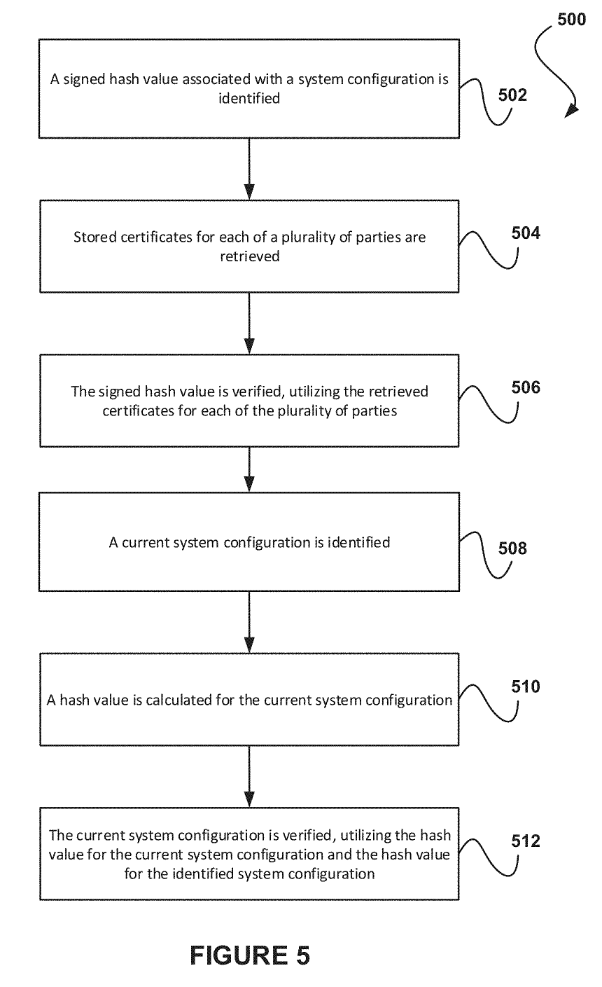

FIG. 5 illustrates method 500 for verifying signatures and configurations, in accordance with one embodiment. As an option, the method 500 may be carried out in the context of the details of FIGS. 1-4. Of course, however, the method 500 may be carried out in any desired environment. Further, the aforementioned definitions may equally apply to the description below.

As shown in operation 502, a signed hash value associated with a system configuration is identified. In one embodiment, the signed hash value may include a digital signature. For example, the signed hash value may include a digital signature created utilizing private keys for a plurality of parties. In another embodiment, the signed hash value may be identified by retrieving the value from trusted and/or secure storage. In yet another embodiment, the signed hash value may be identified in response to one or more criteria. For example, the signed hash value may be identified in response to one or more of system start up, a request for system configuration verification, a request to use the system configuration instead of another configuration, etc.

Additionally, as shown in operation 504, stored certificates for each of a plurality of parties are retrieved. In one embodiment, each of the stored certificates may include a cryptographic certificate, such as a public key of the party that is signed and encrypted using a private key of a certificate authority. In another embodiment, each of the stored certificates may be retrieved from a trusted and secure location (e.g., of the system, of an external system, etc.).

Further, as shown in operation 506, the signed hash value is verified, utilizing the retrieved certificates for each of the plurality of parties. In one embodiment, the signed hash value may include a signature. In another embodiment, verifying the signed hash value may include performing a signature check on the signed hash value, using the retrieved certificates. For example, the signed hash value may be decrypted with public key for each party (obtained via the retrieved certificate for each party) to produce a digest (e.g., the hash value).

Further still, in one embodiment, if the verification of the signed hash value fails, one or more actions may be performed. For example, if it is determined that the hash value was not signed by each of the plurality of parties, the system may not boot, the system may halt, one or more parties may be notified of the failed signature, the system may boot to a default configuration, etc. In another example, at system start-up time, or anytime the configuration needs to be verified unchanged, a locked-down and known-good boot image may verify the digital signature for each party on each firmware image or configuration block. If one of the signature checks fail, the system may halt, or may continue to a normal operating state and may inform one or more parties of the failed digital signature, depending on the pre-programmed policy or user input.

Also, as shown in operation 508, a current system configuration is identified. In one embodiment, the current system configuration may include a hardware and/or software configuration that is currently being used by the system. In another embodiment, the current system configuration may include a system configuration that is used during a start-up of the system.

In addition, as shown in operation 510, a hash value is calculated for the current system configuration. In one embodiment, the hash value may include a digest. In another embodiment, the hash value may be calculated utilizing a cryptographic hash function. For example, the cryptographic hash function may be applied to the current system configuration to produce a digest.

Furthermore, as shown in operation 512, the current system configuration is verified, utilizing the hash value for the current system configuration and the hash value for the identified system configuration. In one embodiment, the verifying may include comparing the hash value for the current system configuration to the hash value for the identified system configuration (e.g., that was obtained by verifying the signed hash value by decrypting the digest with each of the public keys, etc.). In another embodiment, if the verification of the current system configuration fails, one or more actions may be performed. For example, if it is determined that the hash value for the current system configuration does not match the hash value for the identified system configuration, the system may not boot, the system may halt, one or more parties may be notified of the failed signature, the system may boot to a default configuration, etc.

In this way, mutual consent by all of the plurality of parties may be required for a system configuration in order for the system configuration to be implemented by a system.

Further still, in one embodiment, any changes to the system configuration may require re-signing of the changed system configuration by each of the parties. For example, current system configuration changes (e.g., to the BMC, UEFI, etc.) may require re-signing of the hash value for the changed system configuration by each of the plurality of parties.

Also, in one embodiment, multiple system configurations may exist. In another embodiment, each of the multiple system configurations may have an associated timestamp (or the configurations may be ranked according to creation date, etc.). In yet another embodiment, a system may start with a most recent configuration, and may utilize the configuration if the system can verify the configuration (e.g. verify that all parties signed the configuration, etc.). In still another embodiment, if the system cannot verify the most recent configuration, the system may move to next recent configuration, etc. until a configuration is verified. The first verified configuration may then be implemented by the system.

For example, multiple coincident storage spaces may exist for each block of stored content firmware or configuration. The verification mechanism may check signatures of all, and may select the most recent version for which all signatures are valid. A configuration change made by one of the parties may result in a new copy of the content, incorporating the change, and may need to be re-signed by all parties.

Additionally, in one embodiment, a base configuration and separate change configurations to that base configuration may be implemented. For example, a base configuration may be saved within the system, and incremental changes to this base configuration may be saved individually. In another embodiment, each change may be verified independently by the system (e.g. verify that all parties signed the change, etc.) before the change is implemented. In another embodiment, each change may be incorporated to the base configuration, but changes that are not then verified may be rolled back, removed, etc.

For example, multiple images may be implemented as a base image and a journal of changes applied to it. If the base image is kept statically in its original form, the changes in the journal may be applied before the image is verified and used. In another example, every change may be integrated in to the base image, and the journal may be used as an undo/re-do list to enable rolling back unverified changes.

It will be clear that the various features of the foregoing systems and/or methodologies may be combined in any way, creating a plurality of combinations from the descriptions presented above.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer program embodied on a tangible computer readable medium, comprising:
computer code for identifying a stored configuration of a system;
computer code for determining whether the stored configuration of the system includes digital signatures of each of a plurality of parties; and
computer code for conditionally implementing a current configuration of the system, based on the determining.

2. The computer program of claim 1, wherein the stored configuration of the system includes a firmware image.

3. The computer program of claim 1, wherein the stored configuration of the system includes a configuration of one or more sub-modules of the system.

4. The computer program of claim 1, wherein the plurality of parties include at least one lessor of the system and at least one lessee of the system.

5. The computer program of claim 1, wherein determining whether the stored configuration of the system includes digital signatures of each of the plurality of parties includes retrieving stored certificates for each of the plurality of parties and verifying each of the digital signatures of each of the plurality of parties, utilizing the retrieved certificates.

6. The computer program of claim 1, wherein the digital signatures of the plurality of parties are included within the stored configuration of the system as a result of creating a mutually secured configuration.

7. The computer program of claim 6, wherein creating the mutually secured configuration includes creating and storing a certificate for each of the plurality of parties.

8. The computer program of claim 6, wherein creating the mutually secured configuration includes calculating a hash value for the stored configuration of the system.

9. The computer program of claim 8, wherein creating the mutually secured configuration includes applying a signature of each of the plurality of parties to the hash value.

10. A method, comprising:
identifying a stored configuration of a system;
determining whether the stored configuration of the system includes digital signatures of each of a plurality of parties; and
conditionally implementing a current configuration of the system, based on the determining.

11. The method of claim 1, wherein the stored configuration of the system includes a firmware image.

12. The method of claim 1, wherein the stored configuration of the system includes a configuration of one or more sub-modules of the system.

13. The method of claim 1, wherein the plurality of parties include at least one lessor of the system and at least one lessee of the system.

14. The method of claim 1, wherein determining whether the stored configuration of the system includes digital signatures of each of the plurality of parties includes retrieving stored certificates for each of the plurality of parties and verifying each of the digital signatures of each of the plurality of parties, utilizing the retrieved certificates.

15. The method of claim 1, wherein the digital signatures of the plurality of parties are included within the stored configuration of the system as a result of creating a mutually secured configuration.

16. The method of claim 15, wherein creating the mutually secured configuration includes creating and storing a certificate for each of the plurality of parties.

17. The method of claim 15, wherein creating the mutually secured configuration includes calculating a hash value for the stored configuration of the system.

18. The method of claim 17, wherein creating the mutually secured configuration includes applying a signature of each of the plurality of parties to the hash value.

19. A system, comprising:
a processor and logic integrated with and/or executable by the processor, the logic being configured to:
identify a system configuration;
calculate a hash value for the system configuration;
create a signed hash value, utilizing the hash value and a plurality of private keys; and
store the signed hash value.

20. The system of claim 19, wherein the processor is coupled to memory via a bus.
